(19) United States
(12) Patent Application Publication
(10) Pub. No.: US 2011/0157034 A1
(43) Pub. Date: Jun. 30, 2011

(54) PORTABLE ELECTRONIC DEVICE WITH SOLAR CHARGING FUNCTION

(75) Inventor: CHUN-AN CHEN, Tu-Cheng (TW)

(73) Assignee: CHI MEI COMMUNICATION SYSTEMS, INC., Tu-Cheng City (TW)

(21) Appl. No.: 12/766,213

(22) Filed: Apr. 23, 2010

(30) Foreign Application Priority Data
Dec. 25, 2009 (CN) 200910312287.0

(51) Int. Cl. G06F 3/041; H01M 10/46

(52) U.S. Cl. 345/173; 320/101

(57) ABSTRACT

An exemplary portable electronic device with solar charging function includes a main body, a display module, and solar converting device. The display module and the solar converting device are installed in the main body. The main body includes a circuit board, and the display module and the solar converting device are electrically connected to the circuit board. The solar converting device is fixedly disposed at one side of the display module, and capable of absorbing solar energy and converting the solar energy into electrical energy to power the portable electronic device with solar charging function.

### BACKGROUND

1. Technical Field

The disclosure generally relates to portable electronic devices, and more particularly, to a portable electronic device with solar charging function.

2. Description of the Related Art

Nowadays, portable electronic devices, such as mobile phones, personal digital assistants (PDAs), are generally equipped with chargeable batteries. When the battery power is too low or empty, a power source is required to charge the battery via a corresponding charger.

However, in situations when the power source is not available, the charger cannot be connected to the power source to charge the portable electronic devices. Thus, the portable electronic device is at risk to lose functions from losing power.

Therefore, there is room for improvement within the art.

### BRIEF DESCRIPTION OF THE DRAWINGS

Many aspects of a portable electronic device with solar charging function can be better understood with reference to the following drawings. The components in the drawings are not necessarily drawn to scale, the emphasis instead being placed upon clearly illustrating the principles of the exemplary portable electronic device with solar charging function. Moreover, in the drawings, like reference numerals designate corresponding parts throughout the several views. Wherever possible, the same reference numbers are used throughout the drawings to refer to the same or like elements of an embodiment.

FIG. 1 is a schematic view of a portable electronic device with solar charging function, according to an exemplary embodiment.

FIG. 2 is a partially exploded view of the portable electronic device with solar charging function shown in FIG. 1.

### DETAILED DESCRIPTION

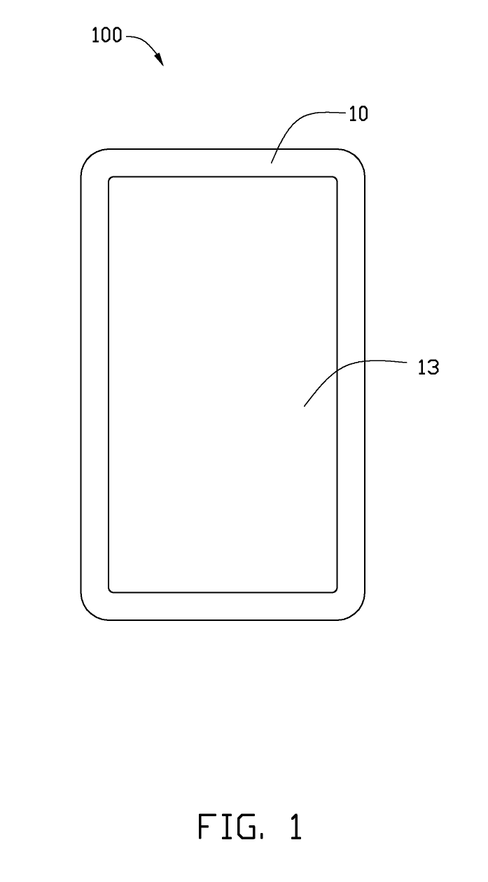

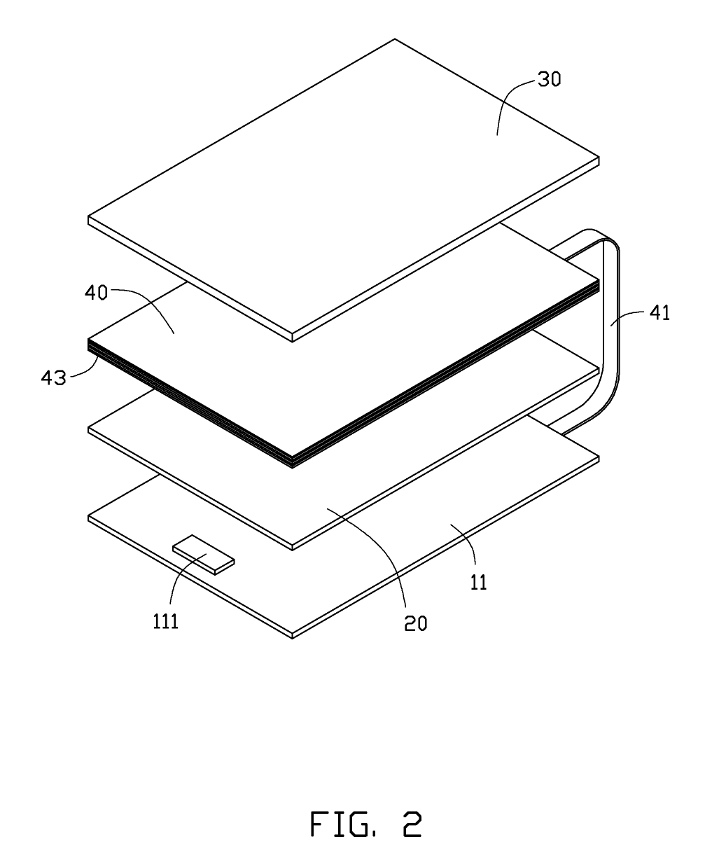

FIGS. 1-2 show an exemplary embodiment of a portable electronic device with solar charging function 100, which may be a PDA, or a mobile phone. A mobile phone is used here as an example, for describing details of the portable electronic device with solar charging function 100. The portable electronic device with solar charging function 100 includes a main body 10, a display module 20, a touch panel 30, and a solar converting device 40. The display module 20, the touch panel 30, and the solar converting device 40 are fixed together and are installed in the main body 10.

The main body 10 may be the housing of the portable electronic device with solar charging function 100. A circuit board 11 is installed in the main body 10. The circuit board 11 may be an existing printed circuit board (PCB). The circuit board 11 includes a charging circuit 111, which works in cooperation with a power source capable of charging a battery (not shown) of the portable electronic device with solar charging function 100 or directly supplying electrical energy for the portable electronic device with solar charging function 100. The main body 10 includes a display section 13, which is located on the surface of the main body 10 and made from transparent materials. The display section 13 is the user interface, and can be capable of displaying different information and inputting various operating instructions.

The display module 20 may be an existing display screen, and the touch panel 30 can be an existing touch panel, such as a resistive touch panel. The display module 20 and the touch panel 30 are electrically connected to the circuit board 11 to transmit a variety of corresponding operating signals. In detail, the display module 20 and the touch panel 30 are leveled with the display section 13, and the touch panel 30 is adjacent to the display section 13. Thus, the users can observe different information on the display module 20 and input various operating instructions with the touch panel 30 through the display section 13.

The solar converting device 40 is installed between the display module 20 and the touch panel 30. The solar converting device 40 is made from transparent silicon materials. Thus, the users can normally observe a variety of information on the display module 20 through the touch panel 30 and the solar converting device 40. The solar converting device 40 is about the same size as the display section 13 to absorb the maximum amount of solar energy through the display section 13, and converts the solar energy into corresponding electrical energy.

The solar converting device 40 includes a connecting member 41 which may be an existing flexible flat cable (FFC) or flexible circuit board (FCB). The solar converting device 40 is electrically connected to the circuit board 11 through the connecting member 41 to transmit the electrical energy to the charging circuit 111 on the circuit board 11. Thus, the electrical energy is stored in the charging circuit 111 to charge the battery or is directly supplied to the portable electronic device with solar charging function 100. Moreover, one end of the connecting member 41 is electrically connected to one side of the solar converting device 40, and the other end is electrically connected to the circuit board 11, which allows the users to be able to observe all the display information on the display module 20 through the display section 13 and the solar converting device 40.

In this embodiment, the solar converting device 40 includes a plurality of solar panels 43, and the thickness of each solar panel is about 0.1 centimeter (cm). The solar panels 43 are stacked on each other and are electrically connected in series, so that the total output voltage of the solar converting device 40 is equal to the level of output voltage of all the solar panels 43. Thus, the output voltage from the solar converting device 40 is adjusted into a charging voltage or a working voltage of the portable electronic device with solar charging function 100, after the corresponding processing circuit, such as an adapter circuit, or transformer circuit.

Referring to FIGS. 1-2, in use, when touching the touch panel 30, various operating instructions are inputted to the portable electronic device with solar charging function 100 to perform a variety of operating commands The users can observe different information, such as messages, pictures, on the display module 20 through the solar converting device 40 and the touch panel 30. Furthermore, the outside light passes through the touch panel 30 to the solar panels 43; the solar converting device 40 absorbs the solar energy and converts the solar energy into corresponding electrical energy. The electrical energy is transmitted to the charging circuit 111 on the circuit board 11 to charge the battery or be directly supplied for the portable electronic device with solar charging function 100.

Furthermore, the touch panel 30 can be omitted, so that the solar converting device 40 is directly leveled with the display section 13 and is stacked on the display module 20 to reduce the thickness and volume of the portable electronic device with solar charging function 100.

In summary, in the portable electronic device with solar charging function 100 of the exemplary embodiment, the solar converting device 40 is located between the display module 20. The touch panel 30, and converts the solar energy into electrical energy, so that the portable electronic device with solar charging function 100 can be conveniently recharged even though a power source is not available. Moreover, the solar converting device 40 is positioned on the display module 20, so there is no need to add an independent solar charging device on or in the portable electronic device with solar charging function 100, resulting in reducing the size of the portable electronic device with solar charging function 100.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A portable electronic device with solar charging function, comprising:
a main body comprising a circuit board;
a display module installed in the main body and electrically connected to the circuit board; and
a solar converting device installed in the main body and electrically connected to the circuit board, wherein the solar converting device is disposed at one side of the display module, and is capable of converting solar energy into electrical energy to power the portable electronic device with solar charging function.

2. The portable electronic device with solar charging function as claimed in claim 1, wherein the circuit board comprises a charging circuit, the solar converting device is electrically connected to the charging circuit for transmitting the electrical energy to the charging circuit to supply electrical energy for the portable electronic device with solar charging function.

3. The portable electronic device with solar charging function as claimed in claim 2, wherein the solar converting device comprises a connecting member, the solar converting device is electrically connected to the circuit board to transmit the electrical energy to the charging circuit by the connecting member.

4. The portable electronic device with solar charging function as claimed in claim 3, wherein the connecting member is a flexible flat cable or a flexible circuit board.

5. The portable electronic device with solar charging function as claimed in claim 1, wherein the solar converting device comprises a plurality of solar panels, the solar panels are fixedly superposed together and electrically connected in series.

6. The portable electronic device with solar charging function as claimed in claim 5, wherein the solar panels are made from transparent silicon materials.

7. The portable electronic device with solar charging function as claimed in claim 1, wherein the main body further comprises a display section, the display section is positioned on the surface of the main body, the display section is leveled with the display module and the solar converting device, and adjacent to the solar converting device.

8. The portable electronic device with solar charging function as claimed in claim 7, wherein the display section is made from transparent materials, the display section, as user interface, is capable of displaying different information and inputting various operating instructions, and the outside light passes through the display section to the solar converting device.

9. The portable electronic device with solar charging function as claimed in claim 7, further comprising a touch panel positioned in the main body, the touch panel is leveled with the display section and electrically connected to the circuit board, and capable of inputting corresponding operating instructions.

10. A portable electronic device with solar charging function, comprising:
a main body comprising a circuit board;
a display module positioned in the main body and electrically connected to the circuit board;
a touch panel positioned in the main body and electrically connected to the circuit board, the touch panel capable of inputting corresponding operating instructions; and
a solar converting device positioned in the main body and electrically connected to the circuit board, wherein the solar converting device is fixedly positioned between the touch panel and the display module, and is capable of absorbing solar energy through the touch panel and converting solar energy into electrical energy.

11. The portable electronic device with solar charging function as claimed in claim 10, wherein the circuit board comprises a charging circuit, the solar converting device is electrically connected to the charging circuit for transmitting the electrical energy to the charging circuit to supply electrical energy for the portable electronic device with solar charging function.

12. The portable electronic device with solar charging function as claimed in claim 11, wherein the solar converting device comprises a connecting member, the solar converting device is electrically connected to the circuit board to transmit the electrical energy to the charging circuit by the connecting member.

13. The portable electronic device with solar charging function as claimed in claim 12, wherein the connecting member is a flexible flat cable or a flexible circuit board.

14. The portable electronic device with solar charging function as claimed in claim 10, wherein the solar converting device comprises a plurality of solar panels, the solar panels are fixedly superposed together and electrically connected in series.

15. The portable electronic device with solar charging function as claimed in claim 15, wherein the solar panels are made from transparent silicon materials.

16. The portable electronic device with solar charging function as claimed in claim 10, wherein the main body further comprises a display section, the display section is positioned on the surface of the main body; the display section is leveled with the display module and the touch pane, and adjacent to the touch pane.

17. The portable electronic device with solar charging function as claimed in claim 16, wherein the display section is made from transparent materials, the display section, as user interface, is capable of displaying different information and inputting various operating instructions, and the outside light passes through the display section to the solar converting device.
